(19) United States
(12) Patent Application Publication
(10) Pub. No.: US 2005/0127124 A1
(43) Pub. Date: Jun. 16, 2005

(54) Device for controlling the dispensing of tape from a roll

(76) Inventor: Mark Panton, Lincoln (GB)

Correspondence Address: Thomas E Sisson;Jackson Walker, Attorneys at Law, Suite 2100 112 E Pecan Street, San Antonio, TX, 78205-1521, US

(21) Appl. No.: 10/500,686

(22) PCT Filed: Oct. 17, 2002
(86) PCT No.: PCT/GB02/04716

(30) Foreign Application Priority Data
Jan. 4, 2002 (GB) 0200144.4
Mar. 18, 2002 (GB) 0206231.3

(51) Int. Cl. B26F 3/02

(52) U.S. Cl. 225/65; 225/66; 225/88

(57) ABSTRACT

A device for controlling the dispensing of tape from a roll comprises a body portion (1) having a first support (2) which rests, in use, on the outer surface of the roll (3), the body portion carrying a cutter bar (4) against which the tape may be drawn to cut the tape, and second and third supports (6 and 7) within the roll, the second and third supports being carried by respective arms (8 and 9) extending from the body portion. At least one of the arms is pivotable or flexible relative to the body portion and is biased outwardly away from the other support to ensure that the second and third supports are held in contact with the internal surface of the roll as the external diameter of the roll decreases in use.

### FIELD OF THE INVENTION

This invention relates to a device for controlling the dispensing of tape from a roll. The device allows improved delivery of sections of adhesive tape from a roll of such tape, for example.

### BACKGROUND OF THE INVENTION

Adhesive tape is a simple form of semi-permanent fixing. Generally, adhesive tape is supplied to the user in the form of a roll made from a continuous strip of tape. The user can therefore peel off the desired length of tape, cut it, and then apply it to whatever material the user wishes.

Although the use of adhesive tape is a relatively simple exercise, sometimes the user can become frustrated by the constant need to find the free end of the adhesive tape each time a section of tape is removed from the roll. This minor chore can become a major task for users with impairments such as poor eyesight or arthritis.

At present, this common flaw of adhesive tape technology is dealt with by the use of adhesive tape dispensers. These dispensers come in a wide range of forms, but they have a common operation mechanism, which involves holding the adhesive tape roll in a housing so that the tape can be unwound to a desired length before a section of tape is removed from the body using a cutting element, which is also attached to the housing.

Adhesive tape dispensers are an effective method of providing sections of tape from a roll of adhesive tape. However, adhesive tape rolls come in many different sizes and as a result, there are a wide range of tape dispensers to accommodate them. Users can find themselves forced to buy different tape dispensers to use with different size tape roll, which can lead to unnecessary expense.

### SUMMARY OF THE INVENTION

The invention provides a device for controlling the dispensing of tape from a roll, comprising a body portion having a first support which rests, in use, on the outer surface of the roll, the body portion carrying a cutter bar against which the tape may be drawn to cut the tape, and second and third supports within the roll, the second and third supports being carried by respective arms extending from the body portion, at least one of the arms being pivotable or flexible relative thereto and being biased outwardly away from the other support to ensure that the second and third supports are held in contact with the internal surface of the roll as the external diameter of the roll decreases in use.

Preferably, the arms are in the form of generally rectangular frame members extending from the body portion, the side of each frame remote from the body portion being split into two parts and the other opposed side members of each frame being resiliently deflectable to permit introduction of the roll through the opened-out splits, the sides of the frames with the openings constituting the second and third supports.

The body portion, the supports and the arms are suitably integrally formed from a resilient plastics material, the biasing of the arms resulting from resilient deformation thereof.

The body portion may be provided with an opening between the first support and the cutter bar through which, in use, the tape from the roll can be led. The edge of the opening which faces away from the roll preferably makes an oblique angle with the axis of rotation of the roll, whereby the cut end of the tape is deflected, when at rest, out of alignment with the remainder of the tape on the roll.

The cutter bar is preferably positioned so as to make an oblique angle with the axis of rotation of the roll, to assist in cutting the tape progressively. The cutter bar preferably includes a toothed metal insert.

The second and third supports preferably both contact the roll on the same side of the axis of rotation of the roll as the first support.

The device of the invention provides a simple and convenient way to control the dispensing of tape from a roll, especially self-adhesive tape. It can be made small and light enough to be carried on the roll, and can be adapted to fit on to a range of different sizes of roll.

### BRIEF DESCRIPTION OF THE PREFERRED EMBODIMENTS

In the drawings, which illustrate exemplary embodiments of the invention:

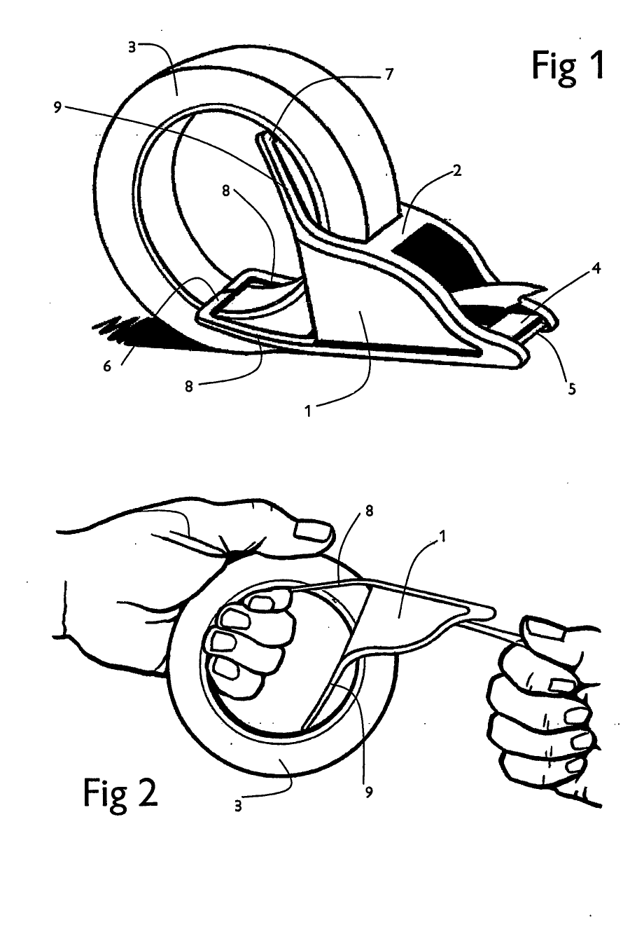

FIG. 1 is a perspective view of a tape control device mounted on a roll of self-adhesive tape;

FIG. 2 is a side elevation illustrating one mode of use of the device shown in FIG. 1;

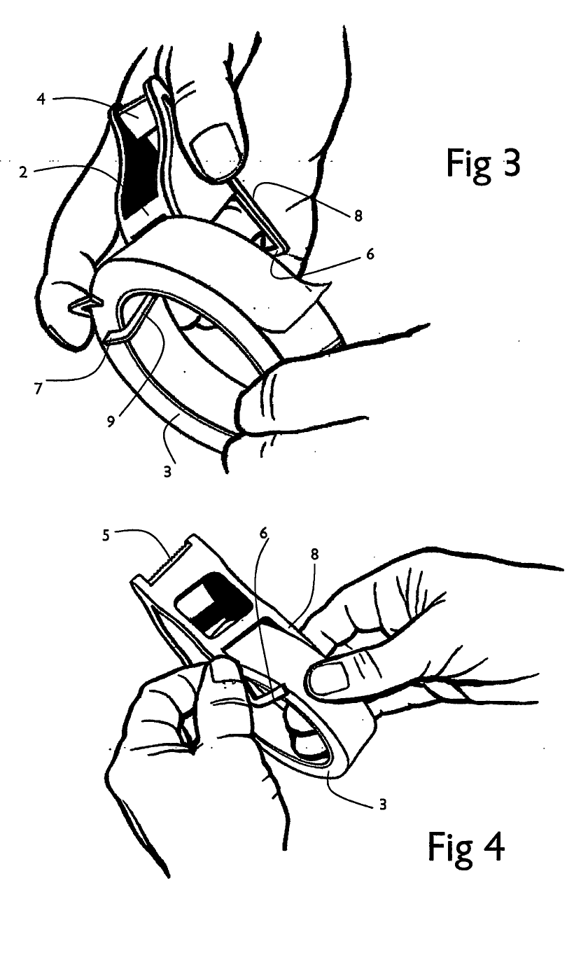

FIGS. 3 and 4 are views showing the fitting of the device on to the roll of tape;

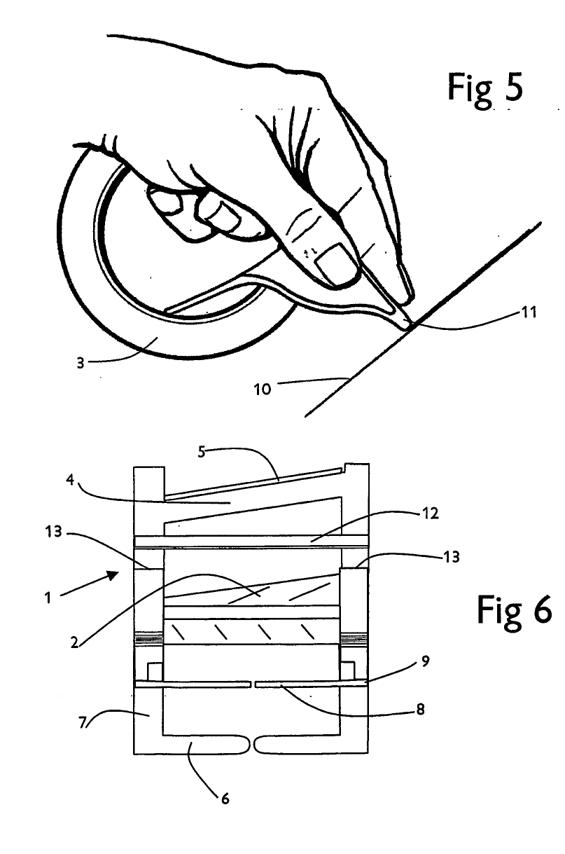

FIG. 5 is a side elevation illustrating the use of the device to cut the tape when the desired length has been dispensed;

FIG. 6 is a front elevation of an alternative embodiment of the device; and

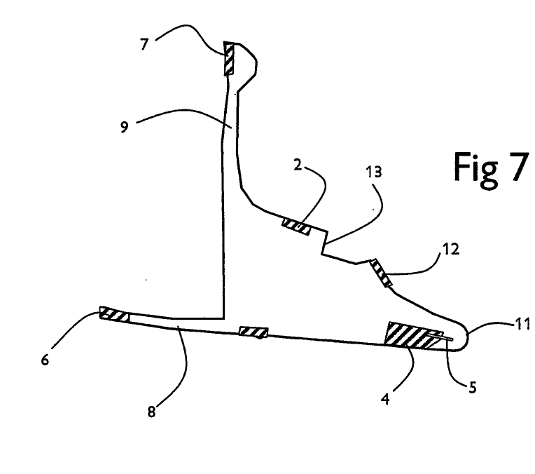

FIG. 7 is a sectional elevation of the device shown in FIG. 6.

### DETAILED DESCRIPTION OF THE DRAWINGS

Referring first to FIGS. 1 and 2, the device suitably consists of a unitary plastics moulding in a resilient plastics material such as polyethylene. A body portion 1 has a transverse support bar 2 which engages the outer surface of a tape roll 3, in use. The body portion 1 also mounts a cutter bar 4 carrying a serrated metal blade 5 against which the tape may be cut. It will be appreciated that, as an alternative, the outer bar 4 could be formed to provide a cutting or tearing edge, which could be serrated or continuous, without the need for the blade 5, depending on the nature of the tape to be cut. Also, the blade, when provided, could be formed without serrations.

The body portion 1 is also provided with second and third supports 6 and 7 which bear against the internal surface of the roll 3, each being constituted by a pair of opposed tabs carried by a respective resilient arm 8 or 9 extending from the body portion 1 on either side of the roll 3, in use. The tabs and arms 6 and 8, 7 and 9 this constitute, with the body portion 1, a generally rectangular frame with the side remote from the body portion being split.

The legs 8 and 9 are formed so as to be resiliently bendable so that the legs 8 of one pair can be bent towards the legs 9 of the other pair, so that when they are released they urge the second and third supports 6 and 7 into engagement with the internal surface of the roll, thereby holding between the support bar 2 on the external surface of the roll and the second and third supports 6 and 7 on the internal surface. This permits rotation of the roll 3 relative to the device, but without the need for an axle and associated mounting to permit rotation. In practice, when dispensing tape, as shown in FIG. 2, the user will grasp the roll 3 and allow the device to rotate around the roll as the tape is pulled from the roll. The tape can then be pulled upwards into contact with the cutter bar 4 to separate a cut strip of tape from the roll. It will be seen that, in the case of self-adhesive tape, which is normally wound on to the roll with the adhesive side inwards of the roll, the non-adhesive side contacts the cutter bar. In addition to facilitating placing of the tape, as hereinafter described, this has the additional benefit of reducing contamination of the serrated teeth of the blade, where used, with adhesive, prolonging its effectiveness.

The resilience of the legs 8 and 9 also permits the opposed tabs forming the second and third supports to be separated, to permit installation of the device on to the roll, as now described with reference to FIGS. 3 and 4. The roll 3 is held in one hand while the third support 7 and associated legs 9 are fitted over the roll from one side (FIG. 3). The device is then twisted round so as to align it with the roll.

The second support 6 is then positioned within the roll by separating the legs 8 to feed the two halves of the support 6 into the roll engaging the inner surface thereof (FIG. 4). The free end of the tape is then fed through the space between the first support bar 2 and the cutter bar 4.

FIG. 5 illustrates the use of the device when applying tape to a surface, for example adhesive tape in packaging use. The tape is applied to the surface 10 and is unrolled to the desired length by holding on to the roll in conventional manner. When it is desired by the user to cut the tape, the device is grasped by the user, and the nose 11 of the device adjacent to the cutter bar is held against the surface 10 at the position where the tape is to be cut. Rotating the device as shown in FIG. 5 brings the tape into contact with the serrated blade, causing it to be severed. The blade is suitably set at an oblique angle so that the tape is cut progressively, rendering the cutting action easier. The upper surface of the first support 2 is suitably set at an oblique angle to the axis of rotation of the roll so as to displace the cut end of the tape sideways out of alignment with the roll by a small amount. This ensures that the free end of the tape may be readily detached from the roll when required for use.

FIGS. 6 and 7 illustrate an alternative embodiment of the device having two principal enhancements over the embodiment shown in FIGS. 1 to 5. Firstly, a stopper bar 12 is positioned across the body portion adjacent to the cutter bar 4, but with an opening for tape to pass between the stopper bar 12 and the first support 2. This serves not only to protect the user's thumb from contact with the blade 5 when first grasping the cut end of the tape to feed it through the device, but also to prevent accidental cutting of the tape, for example when using the device to assist in wrapping small packages.

Secondly, the body portion 1 is provided with a pair of notches 13 to permit the device to be located more readily on an edge of an object to which tape is to be applied, for example a parcel, so that the free end of the tape may first be attached to the side of the object. The tape roll can then be pulled to roll out the tape over the upper surface of the object.

1. A device for controlling the dispensing of tape from a roll, comprising a body portion having a first support which rests, in use, on the outer surface of the roll, the body portion carrying a cutter bar against which the tape may be drawn to cut the tape, and second and third supports within the roll, the second and third supports being carried by respective arms extending from the body portion, at least one of the arms being pivotable or flexible relative thereto and being biased outwardly away from the other support to ensure that the second and third supports are held in contact with the internal surface of the roll as the external diameter of the roll decreases in use.

2. A device according to claim 1, wherein the arms are in the form of generally rectangular frame members extending from the body portion, the side of each frame remote from the body portion being split into two parts and the other opposed side members of each frame being resiliently deflectable to permit introduction of the roll through the opened-out splits, the sides of the frames with the openings constituting the second and third supports.

3. A device according to claim 1, wherein the body portion, the supports and the arms are integrally formed from a resilient plastics material, the biasing of the arms resulting from resilient deformation thereof.

4. A device according to claim 1, wherein the body portion has an opening between the first support and the cutter bar through which, in use, the tape from the roll can be led.

5. A device according to claim 4, wherein the edge of the opening which faces away from the roll makes an oblique angle with the axis of rotation of the roll, whereby the cut end of the tape is deflected, when at rest, out of alignment with the remainder of the tape on the roll.

6. A device according to claim 1, wherein the cutter bar is positioned so as to make an oblique angle with the axis of rotation of the roll.

7. A device according to claim 1, wherein the cutter bar is a toothed metal insert.

8. A device according to claim 1, wherein the second and third supports both contact the roll on the same side of the axis of rotation of the roll as the first support.
